(19) United States
(12) Patent Application Publication
(10) Pub. No.: US 2023/0197431 A1
(43) Pub. Date: Jun. 22, 2023

(54) Direct Single Particle Compositional Analysis

(71) Applicant: PerkinElmer Health Sciences Canada, Inc., Woodbridge (CA)

(72) Inventor: Chady Stephan, Brampton (CA)

(21) Appl. No.: 18/109,119

(22) Filed: Feb. 13, 2023

Related U.S. Application Data
(63) Continuation-in-part of application No. 16/519,925, filed on Jul. 23, 2019, now Pat. No. 11,581,177.
(60) Provisional application No. 62/703,428, filed on Jul. 25, 2018.

(51) Int. Cl. H01J 49/10; H01J 49/04; H01J 49/16; G01N 30/72; G01N 21/73

(52) U.S. Cl. CPC H01J 49/105; H01J 49/045; H01J 49/049; H01J 49/107; H01J 49/167; G01N 30/7273; G01N 21/73

(57) ABSTRACT

Systems and methods for use in introducing samples to an analytical device for single particle compositional analysis. Suitable analytical devices include, for example, an inductively coupled plasma-optical emission spectrometer. Prior to introduction to the analytical device, the sample gas is exchanged with argon gas, for example, using a gas exchange device. The analytical device may be calibrated with a liquid sample which is aerosolized prior to entry into the analytical device.

### CROSS-REFERENCE TO RELATED APPLICATIONS

This application is a continuation-in-part of co-pending application U.S. Ser. No. 16/519,925, filed Jul. 23, 2019, which claims priority to U.S. Ser. No. 62/703,428, filed Jul. 25, 2018, each of which is incorporated by reference in its entirety. This application is related to co-pending application U.S. Ser. No. 18/109,094, filed Feb. 13, 2023, which is incorporated by reference in its entirety.

### FIELD

Aspects described herein generally relate to systems and methods for single particle compositional analysis. Suitable analytical devices include, for example, an inductively coupled plasma-optical emission spectrometer.

### BACKGROUND

It is often desirable to measure particulate matter in ambient environments and identify an origin of the particulate matter. Such identification can be difficult if the particulate matter is present in air or other gases.

Mass analysis is an effective analytical technique for identifying unknown compounds and for determining the precise mass of known compounds. Advantageously, compounds can be detected or analyzed in minute quantities, allowing compounds to be identified at very low concentrations in chemically complex mixtures. Spectrometry, including inductively coupled plasma-optical emission spectrometry (ICP-OES), has found practical application in a variety of fields, including medicine, pharmacology, food sciences, semi-conductor manufacturing, environmental sciences, and security. For example, preparation of semiconductors requires process gases with no, or extremely low amounts of, contaminants, and hence requires suitable testing methods.

A typical mass spectrometer includes an ion source that ionizes compounds, metals and particles of interest. Conventional ion sources may, for example, create ions by electrospray, chemical ionization or plasma ionization. The ions are passed to an analyzer region, where they are separated according to their mass (m)-to-charge (z) ratios (m/z). The separated ions are then detected at a detector. A signal from the detector may be sent to a computing or similar device where the m/z ratios may be stored together with their relative abundance for presentation in the format of an m/z spectrum.

In ICP-OES analysis, a sample may be injected into a plasma and the resulting excitation of the sample in the plasma generates charged ions. As various molecules in the sample break up into their respective atoms, which then lose electrons and recombine repeatedly in the plasma, they emit radiation at a characteristic wavelength of the elements involved. A spectrometer may receive light from a light source (e.g., ICP-OES plasma or other light source including but not limited to a telescope, microscope, or other light-generating or light-conveying system.)

In inductively coupled plasma—time of flight (ICP-TOF) analysis, a sample may be injected into a plasma to generate ions. An electric field (generated by electromagnetic induction) is utilized to accelerate the generated ions through the same electrical potential, and the time each ion takes to reach the detector is measured. The sample ions with different masses are then accelerated to the same (known) kinetic energy and the time taken for each ion to reach a detector at a known distance is measured.

### SUMMARY

The following presents a simplified summary of various features described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art, and to overcome other limitations that will be apparent upon reading and understanding the present specification, aspects described herein are directed towards systems and methods for single particle compositional analysis. Certain aspect, configurations, embodiments, examples and illustrations are described of methods and systems that can be used to identify two, three, four, five, or more elements in a particle. The identified elements can then be used to identify a source of the particle if desired.

One aspect is directed to a method for single particle compositional analysis. A gaseous stream containing a plurality of particles is transferred from a gaseous source to a gas exchange device. The gaseous stream is passed through the gas exchange device. Exchange gas is injected through the gas exchange device countercurrent to the gaseous stream, wherein the plurality of particles is transferred to the exchange gas. The exchange gas containing particles is outputted to an analytical device. The exchange gas is analyzed in the analytical device by ionizing a sample of the exchange gas containing the plurality of particles, wherein the plurality of particles comprise a particle comprising a first element and a second element, and wherein ionization of the sample provides excited, ionized first element and excited, ionized second element; simultaneously detecting a wavelength of an optical emission from each of the excited, ionized first element and the excited, ionized second element to identify at least the first element in the particle from the plurality of particles using the optical emission from the excited, ionized first element, and to identify at least the second element in the particle from the plurality of particles using the optical emission from the excited, ionized second element; and using the identified first element and the identified second element to identify a source of the particle.

A further aspect relates to a system for single particle compositional analysis, the system having at least a gas exchange apparatus, a sample introduction device, an ionization device, and an optical detector. The gas exchange apparatus has a gas exchange device having an inlet aperture and an outlet aperture; and a conduit coupled to the outlet aperture and configured to transfer output of the gas exchange device to the sample introduction device, the output comprising exchange gas comprising a plurality of particles. The sample introduction device is configured to provide an individual particle from the plurality of particles, wherein the provided individual particle comprises an average diameter of about 100 nm to about 100 microns. An ionization device fluidically is coupled to the sample introduction device and configured to ionize elemental species present in the provided individual particle. An optical detector configured to simultaneously detect an optical response from each of the ionized elemental species from the provided individual particle.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is an illustration showing two elemental species present together in individual particles, in accordance with certain examples;

FIG. 2 is another illustration showing two elemental species present together in individual particles, in accordance with certain embodiments;

FIG. 3 is another illustration showing two elemental species present together in individual particles as a core shell scenario, in accordance with certain embodiments;

FIG. 4 is an illustration of a process to detect two or more elemental species present in an individual particle, in accordance with certain examples;

FIG. 5 depicts a flow chart of a method in accordance with certain examples.

FIG. 6 depicts an illustrative arrangement for a system for introducing liquid and gaseous samples to an analytical device, showing a cross-sectional view of a chamber and a cross-sectional view of a gas exchange device coupled to the chamber, in accordance with one or more example embodiments.

FIG. 7 depicts another illustrative arrangement for a system for introducing liquid and gaseous samples to an analytical device, showing cross-sectional views of two chambers and a cross-sectional view of a gas exchange device that may be coupled to one of the chambers, in accordance with one or more example embodiments.

FIG. 8 depicts an illustrative arrangement for a system for introducing liquid and gaseous samples to an analytical device, showing a cross-sectional view of a chamber and a cross-sectional view of a gas exchange device coupled to the chamber, with liquid sample being introduced to the inlet of the chamber and gaseous sample being introduced past the outlet of the chamber, in accordance with one or more example embodiments.

FIG. 9 depicts a flow chart of two gas exchange devices connected to a single analytical device in accordance with some embodiments.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards systems and methods for analyzing two or more elements in a single particle, and preparing liquid and gaseous samples for introduction into an analytical device, also referred to as, for example, an analytical instrument or an analyzer.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged,” and similar terms, is meant to include both direct and indirect, as well as fixed or removable, mounting, connecting, coupling, positioning, and engaging by any suitable methods known to those of skill in the art.

Certain illustrations of methods, systems and devices are provided below to facilitate a better understanding of the technology described herein. In some instances, reference is made to a single particle being analyzed for its elemental content or some portion thereof. It will be recognized by the person of ordinary skill in the art, given the benefit of this disclosure, that more than one particle can be analyzed, and the reference to single particle does not mean that only a single particle is or can be analyzed using the methods, systems and devices described herein.

In some examples, the methods, systems and devices described herein can be used to detect two or more than two elements, e.g. three, four, five, or more elements, within a single individual particle. The single particle may be present as an individual particle or a stable aggregate or association or system of particles.

Without wishing to be bound by this particular illustration, by detecting two or more elements within a single particle it can be possible to determine a source of the particle. For example, a single particle comprising copper and zinc can be linked to a brass material, a single particle comprising iron and chromium can be linked to a steel material, a single particle comprising two particular elements can be linked to a wear site in an engine, a single particle comprising two particular elements can be linked to a source of specific air borne particles, a single particle comprising two or three particular elements can be linked to gun powder, etc. In some examples, the exact size of the single particle, e.g., an average particle diameter, may vary from about 0.5 microns up to about 100 microns, more particularly about 0.5 microns to about 50 microns or about 0.5 microns to about 10 microns, though smaller or larger particles can also be analyzed using the methods and systems described herein. If desired, both the identity of the element(s) in a single particle and an amount of the element(s) in the single particle can be determined.

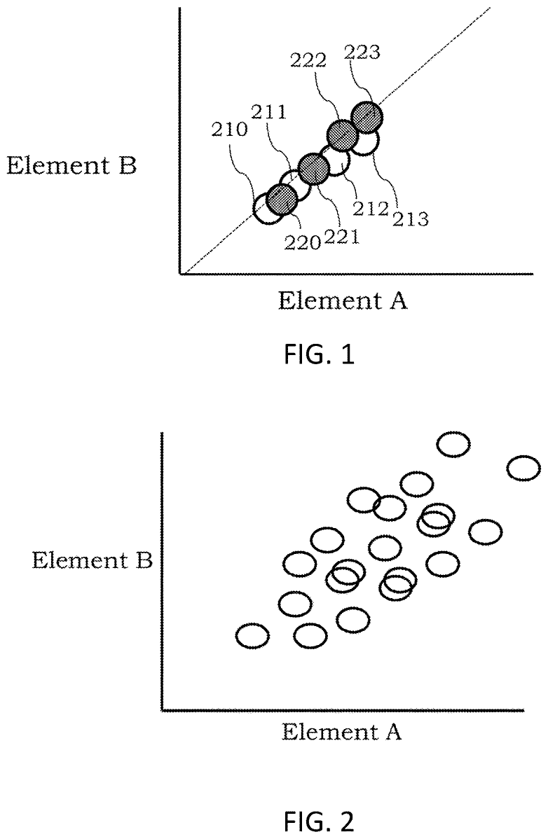

In certain embodiments, the methods, systems and devices described herein can be used, for example, to detect the presence of two or more elements in a single particle. An illustration is shown in FIG. 1 where the particles provide optical signals 210-213 and 220-223, e.g., optical emission or optical absorption signals. As each particle is introduced into an ionization source, the elements A and B are atomized and/or ionized and provided to a downstream optical detector. Because both elements are present in a single particle, both elements A and B are simultaneously detected by the optical detector. As noted in more detail below, each of elements A and B can emit or absorb light at a characteristic wavelength that can be used to determine the identity and amount of each element present in the particle. The illustration shown in FIG. 1 assumes the elements A and B are present in a fixed ratio in each of the individual particles and a fixed response is observed for the elements in any one particle.

In some examples, the elements A and B may be present at variable ratios in different particles where some particles have higher amounts of one element than other particles. An illustration of a possible optical response is shown in FIG. 2 where elements A and B exist together in a variable ratio in individual particles. Different amounts of elements A and B may be detected in different individual particles, which can result in spreading out of the optical signals. In some instances, certain individual particles may comprise only a single element whereas other individual particles may comprise two or more elements.

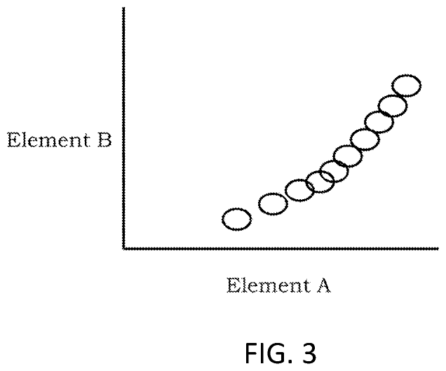

In some examples, the exact nature of the particles where two elements are present together may vary. In some examples, the elements A and B may be bound or coordinated to different groups of the particle, whereas in other instances one or more of the elements A or B can be present in a different structure of the particle that forms a portion of the particle. For example, one of the elements may be present in a core of a core shell particle configuration and the other element can be present in the shell of a core shell particle configuration. An illustration is shown in FIG. 3 where elements A and B exist together with element A being in the core of the particle (with variable core size) and element B being in the shell of the particle (with fixed shell size). An illustration of a possible optical response is shown, which shows that the presence of the core-shell configuration can provide a different response than when the elements are present in a common structural component of a single particle (see FIG. 1).

In certain examples, two or more elements within a single particle can simultaneously be detected using an optical response or signal from each of an ionized first element and an ionized second element to identify at least the first element in a particle and to identify at least the second element in the particle. The identified first element and the identified second element can be used to identify a source of the particle from a plurality of particles. If desired, an amount of each of the ionized first element and the ionized second element can also be determined to quantitate how much of each of the first element and the second element is present in the individual particle. A third element, fourth element, fifth element etc. can also be identified and/or quantified in the individual particle.

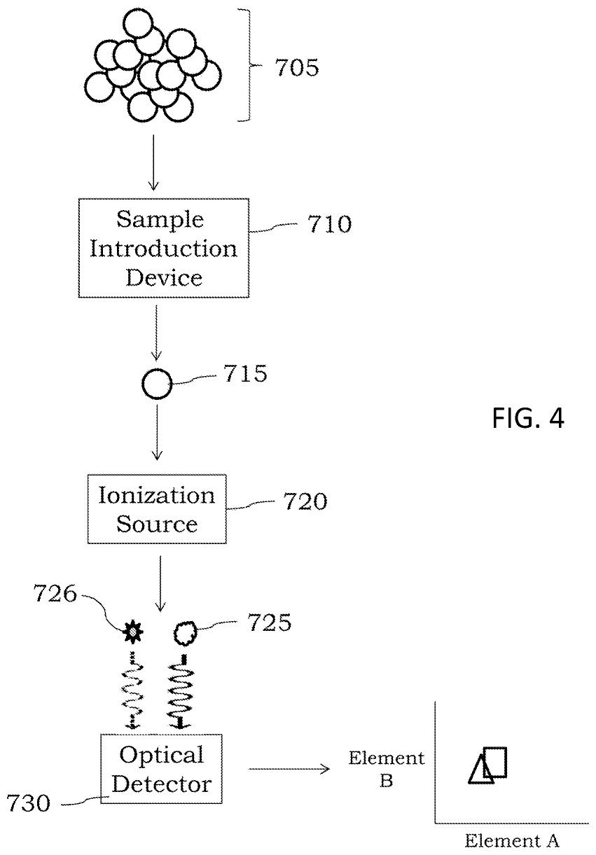

A generalized illustration of a process for identifying at least a first element and at least a second element is shown in FIG. 4. A plurality of individual particles (collectively 705) can be introduced into a sample introduction device 710 to select or provide an individual particle 715 from the plurality of individual particles 705. The provided individual particle 715 can then be provided to an ionization source 720 to ionize the elemental species in the provided individual particle 715. While not shown, each individual particle of the plurality of individual particles can be provided separately to the ionization source 720 to detect the first element and the second element in each provided individual particle, e.g., sequentially. Depending on the exact ionization source selected, the organic elements present in the individual particle 715 are atomized/ionized and generally do not emit light (or absorb light) at similar wavelengths as any ionized inorganic elemental species. After ionization of the individual particle 715 in the ionization source 720, the elemental species 725, 726 can be provided to an optical detector 730 for detection, or light emitted from or absorbed by the species 725, 726 can be detected by the optical detector 730. The optical detector 730 can be configured to simultaneously detect an optical response for each of the elemental species 725, 726 as shown in the graph in FIG. 4. The detected optical signals for each of elements A and B in each of the individual particles from the plurality of particles 705 can be used to determine a source of the particles. In some examples, the exact optical response or optical signal from the first element and second element can vary. As noted below, in some instances, an optical emission from each of the first element and the second element can simultaneously be detected and used to determine the identity of the elements and how much of each element is present in each individual particle. While the exact emission wavelength varies from element to element and certain elements can emit light at more than a single wavelength, different emission wavelengths can be monitored so that minimal spectral emission wavelength overlap is observed during the simultaneous detection of the two or more elements. In other instances, light absorption by the first element and second element can be used to identify the elements present and/or the amount of the elements that are present in the individual particle.

In some examples, it may be desirable to sample an air space with particles present in gaseous form. For example, in many industrial settings, it may be desirable to keep a level of certain air borne particles below a threshold level to ensure worker safety and/or increase air quality. The air space can be sampled to extract some of the gaseous particles to test whether or not certain types of particles are present. For example, particulate matter can be analyzed to determine selected particles of a desired size, e.g., similar to PM₁₀, PM_{2.5} and PM₁ monitoring, and determine whether or not any particularly hazardous particles are present in the air sample. In some examples where gaseous particles are analyzed, a gas exchange device (GED) may be present as or part of the sample introduction device.

In some embodiments, the ionization source 720 may take many different forms and is generally effective to ionize the elemental species present in each individual particle for elemental analysis. In some examples, the ionization source may be a high temperature ionization source, e.g., one with an average temperature of about 4000 Kelvin or more, such as, for example, a direct current plasma, an inductively coupled plasma, an arc, a spark, or other high temperature ionization sources. The exact ionization source used may vary depending on the particular elements and/or particles to be analyzed, and illustrative ionization sources include those which can atomize and/or ionize the elemental species to be detected, e.g., those ionization sources which can atomize and/or ionize metals, metalloids and other inorganic species or organic species.

In accordance with certain embodiments, single particle inductively coupled plasma devices may be used to process samples from a gas source containing particles. Such devices include ICP-OES and other multi-channel atomic emission or mass spectrometry such as ICP-Time of Flight. Suitable single particle ICP-OES are described in US 20190221417A1, which is incorporated herein by reference in its entirety.

Only certain types of gas may be transferred into ICP-OES devices. Sample gases obtained from, for example, air, cannot be directly introduced into the ICP-OES. ICP-OES utilize an argon plasma, for example, and air would be detrimental to such devices. Thus, prior to entry to an ICP-OES device, the air should be exchanged with a neutral gas such as argon. Such gas exchange may occur via a gas-exchange device wherein particles in the gas sample are quantitatively extracted from the gas sample and transferred to the neutral gas. In addition to air, sources of sample gases may include, for example, helium (He), liquid argon (Lar), liquid nitrogen (LN₂), nitrous oxide (N₂O), nitrogen trifluoride (NF₃), and ammonia (NH₃).

A suitable gas exchange device, sometimes also referred to as a desolvator, is described in US20200035475A1, incorporated herein by reference in its entirety. The gas exchange device enables the use of analytical devices, such as ICP-OES, for detecting particles from gas samples, such as air samples. An exchange gas, typically argon, is introduced into the gas exchange device. Particles from the gas are transferred into the argon exchange gas. The argon gas containing the particles is then introduced into an analytical device.

If there is concern of moisture in the gas, then a two GED system may be used as identified in co-pending application (Attorney Docket 008916.00365), incorporated herein by reference in its entirety, where separate gas exchange devices are used for the gaseous stream and the liquid calibrant stream prior to delivery of the gaseous sample and the calibrant sample to the analytical device.

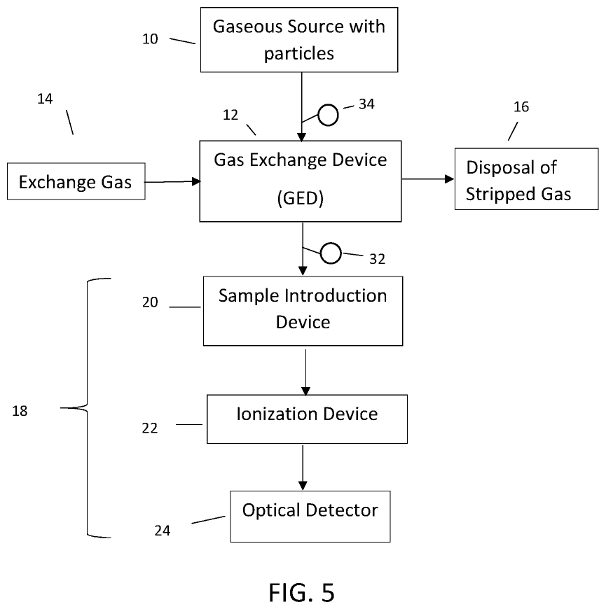

FIG. 5 depicts a flow chart of an example method. Although the elements of FIG. 5 are shown as block diagrams, the disclosure is not so limited. In particular, one or more of the boxes in FIG. 5 may be combined into a single box or the functionality performed by a single box may be divided across multiple existing or new boxes.

A gas exchange device 12 and an analytical device (collectively 18) are used to detect particles in a gas stream. The gas exchange device may also be used to process a liquid calibrant stream to calibrate the analytical device via a method of standard addition using liquid standards.

A sample gas from a gaseous source 10 containing a plurality of particles is introduced into a gas exchange device 12. An exchange gas 14, e.g. argon, is introduced into the gas exchange device. The sample gas is exchanged with the exchange gas such that plurality of particles previously present in the sample gas are transferred to the exchange gas in the gas exchange device 12. The sample gas stripped of particles is removed from the gas exchange device for disposal 16. The exchange gas containing particles exits from the gas exchange device 12 and is transported to analytical device 18 which may include a sample introduction device 20, an ionization device 22, and an optical detector 24.

A mass flow meter 32 may be interfaced between the gas exchange device 12 and the analytical device 20 to control flow rate of the gaseous sample stream. A mass flow meter 34 may also be placed between the gas source 10 and the gas exchange device 12. The system may include any appropriate sensors such as to detect temperature, pressure, and other flow parameters. Any of such meters and sensors may be connected to a computer (not shown) to monitor and adjust the process.

Any suitable gas exchange device may be utilized that can transfer particles out of a gas to an exchange gas, e.g. argon. For example, the gas exchange device may comprise a cylindrical housing, extending along an axis, and enclosing a membrane for removal and transfer of particles from a gas stream to the transfer gas stream. There should be compatibility between the sample gas and the membrane.

When a gaseous sample is processed, the gaseous sample flow rate from the sample source 10 into gas exchange device 12 is measured and controlled using known techniques to limit pressure changes and facilitate proper gas exchange at the enclosed membrane. In certain aspects, a positive pressure is maintained to move the gaseous sample through the system toward and into the gas exchange device 12. The flow rate of exchange gas from the enclosed membrane also may be controlled to be consistent with the flow rate of process gas. In certain aspects, a mass flow meter 32 may be interfaced between the gas exchange device and the analytical device and tied to the mass flow controller. In embodiments, the mass flow meter 32 is in communication with a computer.

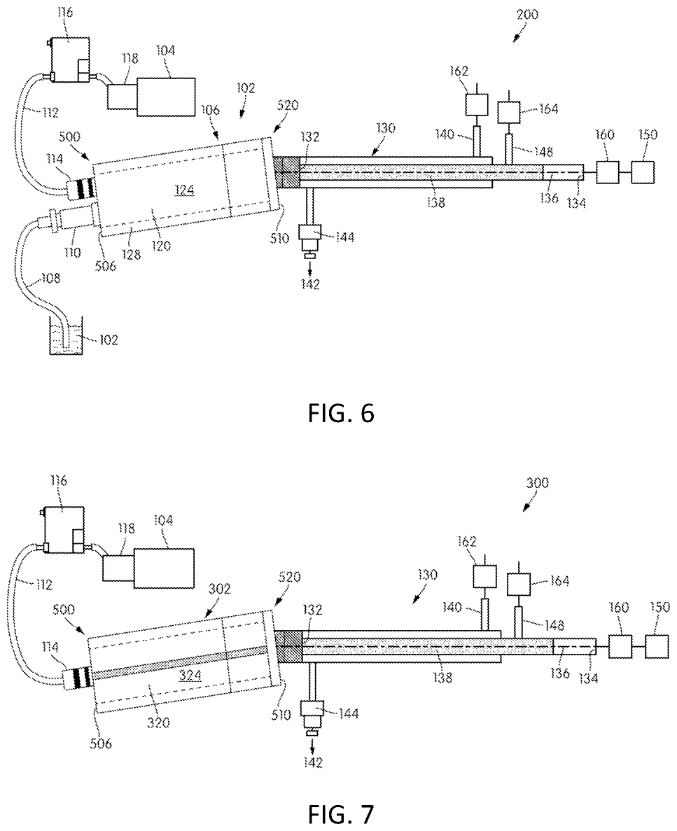

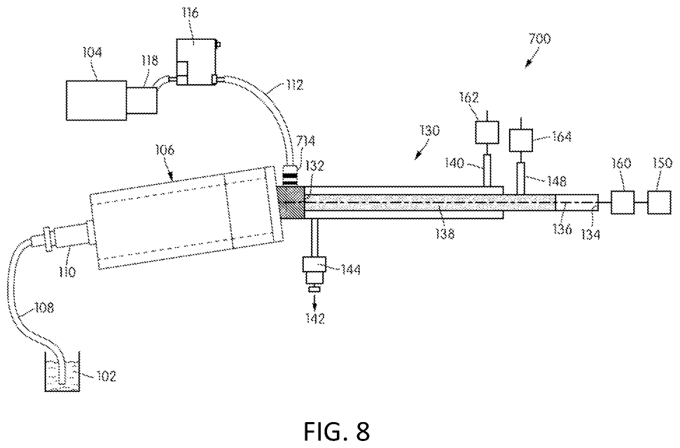

The gas exchange device may be utilized to exchange particles in an air gas sample but also may be used to exchange particles from a nebulized liquid sample containing calibrant particles. FIG. 6 depicts a system for introducing liquid and gaseous samples to an analytical device. FIG. 7 depicts a system for introducing gaseous samples to an analytical device. FIG. 8 depicts a system for introducing liquid and gaseous samples to an analytical device, with liquid sample being introduced to the inlet of the chamber and gaseous sample being introduced past the outlet of the chamber.

Turning first to the gas exchange device 130 shown in FIG. 6. System 200 may be used for preparing a liquid sample or a gaseous sample for introduction to an analytical device. In this example, both the liquid sample from the liquid sample source 102 and the gaseous sample from the gaseous sample source 104 are conveyed to the same chamber 106, depending on which sample is being analyzed. After flowing through chamber 106, the selected sample passes through to a gas exchange device 130.

The gaseous sample may be conveyed, such as by pumping, from the gaseous sample source 104 (which may represent different gas sources) via a gas flow conduit 112 that is coupled to chamber 106 by connector 114. A mass flow controller 116 may be used to control the flow rate of the sample gas from the gaseous sample source 104. A selector valve 118 at the gaseous sample source 104 may be utilized to switch between different gaseous sample sources, such that a variety of gaseous samples each may ultimately be introduced to an analytical device 150.

Gaseous sample flows into interior chamber 120 at inlet end 500, through the interior chamber 120, and exits through outlet end 520. The sample gas enters the gas exchange device through inlet 132, crosses through membrane 138, and exits through outlet 142. The exchange gas enters through inlet 140, crosses through membrane 138, exits through outlet 134, and continues on to analytical device(s) 150. Particles in the sample gas are transferred from the sample gas to the exchange gas.

The liquid sample may be conveyed, such as by pumping, from the liquid sample source 102 via a liquid flow conduit 108 and injected into a nebulizer 110 in which the liquid sample is nebulized into a mist or aerosol. From the nebulizer 110, the liquid sample mist is injected into the chamber 106. In certain aspects, chamber 106 may be a spray chamber such as known to one of skill in the art. The nebulizer 110 is coupled to the inlet wall 506 at the inlet end 500 of the chamber. Any suitable nebulizer may be used. A variety of nebulizers, such as glass or PFA concentric nebulizers, are commercially-available from e.g., Meinhard and Elemental Scientific.

The liquid sample mist flows from the nebulizer 110 into an interior 120 of chamber 106, which is positioned in an interior portion of an outer housing 125 of the chamber 106. The interior 120 may be heated, for example to a temperature in excess of the vaporization temperature of the liquid sample, e.g. 30 to 130° C. In certain embodiments, the temperature in the interior chamber 120 is maintained from about 40° C. to about 150° C., and more preferably between about 70° C. and about 110° C. The resulting aerosol droplets of the liquid sample can then be caused to flow through the interior chamber 120, typically under the influence of the pressure gradient, from the inlet end 500 of the chamber 106 to the outlet end 520 and into the gas exchange device 130.

The interior chamber 120 may have generally circular cross-section and a uniform diameter along its length. In other aspects, the interior chamber 120 may have a cross-section of different shape or may not be uniform along the length of the chamber from inlet end 500 to outlet end 520.

In an embodiment, chamber 106 may be between about 10 cm and about 30 cm in length and between about 5 cm and about 10 cm in diameter, more preferably about 20 cm in length and about 7 cm in diameter. Liquid inlet port has a diameter of between about 10 mm and about 20 mm, more preferably about 0.5 mm. Depending on the desired gas flow from the outlet end 520 of chamber 106, the diameter of outlet port 512 in certain embodiments may range from about 5 mm to about 30 mm.

The interior wall 124 of the interior chamber 120 may be lined with any material that can withstand the elevated temperature in the chamber and the conditions created by the liquid sample aerosol and/or the gaseous sample. In one aspect, the surface is lined with a fluoropolymer, such as PerFluoroAlkoxy (PFA) or polytetrafluoroethylene (PTFE). As discussed below for FIG. 7.

Optionally, a drain or similar opening (not shown) may be located along a lower portion of the inlet end 500 for removal of excess liquid sample condensate that may collect along the bottom 128 of the interior 120.

Either of the flow conduits 108, 112 may be removably connected to its respective inlet port using any known connectors. The liquid flow conduit 108 optionally may be removably connected to the nebulizer 110, with the nebulizer 110 remaining coupled to the inlet end at all times. Connectors should be of a type and size to provide a secure seal to limit leakage of the liquid sample, gaseous sample or process gases and to limit pressure changes throughout the system 200.

Particularly when a gaseous sample is processed, in system 200 or any other embodiments, the gaseous sample flow rate from the sample source 104 through the interior 124 and into gas exchange device 130 is measured and controlled using known devices (e.g., mass flow meters, pressure valves/restrictors, etc.) to limit pressure changes and facilitate proper gas exchange at the enclosed membrane 138. In certain aspects, a positive pressure is maintained to move the gaseous sample through the system 200 toward and into the gas exchange device 130. The flow rate of exchange gas from the enclosed membrane 138 also may be controlled to be consistent with the flow rate of sample gas.

Gas exchange device 130 has an aperture defining an inlet 132 for receiving liquid sample aerosol and gaseous sample from outlet end 520 via conduits and the like such as a push fit connector, threaded connector, or other suitable connectors to provide a sealed connection between chamber 106 and gas exchange device 130. An aperture at the end of the gas exchange device opposite the inlet 132 defines an outlet 134 that is connected to the analytical device 150.

Gas exchange device 130 may be formed from a generally cylindrical housing, extending along an axis 136. Other geometries are of course possible. Preferably, gas exchange device 130 includes an enclosed membrane 138 to allow for transfer of particles from the gaseous sample, or liquid sample aerosol using an exchange, to a carrier gas such as e.g., argon that is compatible with the plasma of an analytical device. In certain aspects, the enclosed membrane 138 may be a fluoropolymer membrane. Gas exchange device may be heated by a heater, e.g., oven (not shown). Heater may be configured to heat the enclosed membrane 138 to a desired temperature (e.g., between about 110° C. and about 160° C. or higher). Various suitable gas exchange devices are commercially available from J-Science Lab Co., Ltd. of Japan, for example

Membrane 138 extends the length of the gas exchange device. Generally the temperature is controlled between 80° and 180° C. Temperature control in conjunction with the exchange gas flow/pressure are the two fundamental parameters that ensure proper/efficient exchange. The pressure within gas exchange device 130 may be measured and controlled by a pressure gauge 144, in flow communication with the interior of the gas exchange device 130. The gas pressure should be constant from the inlet to the outlet of the gas exchange device and sufficiently high to ensure that the exchange gas is being transferred into the enclosed membrane and the sample gas is being transferred out of the enclosed membrane. Suitable pressures include 0.1 to 2 KPa, for example, 0.3 KPa The flow of gaseous sample through inlet 132 and outlet 134 may be controlled using techniques known to those of skill in the art. For example, the exchange gas may be set at a flow rate of 1 to 15 L/min, or 1 to 12 L/min, or 3 to 10 L/min for example 8 L/min in order to obtain the desired pressure.

If additional gas flow is needed to maintain or adjust the pressure across the membrane 138 to obtain a desired gas exchange rate, makeup gas may be introduced into gas exchange device 130 at makeup port 148. Makeup gas may be the same gas as exchange gas or may be a different gas such as nitrogen. The makeup gas may flow through and exit gas exchange device 130 with exchange gas. The makeup gas may also be used to increase the flowrate of the sample gas flow. For example, makeup gas is added a very low flow (0-50 mL) Makeup gas also may be introduced at other positions in system 200 to achieve the desired control of sample gas flow and system pressure. In one example embodiment where the exchange gas is argon, the makeup gas may be nitrogen, and the amount of makeup gas is determined while calibrating the disclosed methods and systems with a liquid standard. Nitrogen, for example, aids in transferring the energy from the argon plasma to the contaminant in the absence of (moisture or water molecule—H₂O).

In regard to gaseous samples, the flow rate or pressure at the outlet 134 of the gas exchange device 130 should be close to or the same as the flow rate or pressure of the sample gas measured at the mass flow controller 116 in order to maintain a linear response of contaminants to concentration. The mass flow meter 160 may be used to measure a flow of gas to the analytical device and the ratio of this value to that set by mass flow controller 116 may be monitored e.g., by the computer. Ideally the flow of gas is at least 98%, or at least 99%, of the flow of the gaseous sample as measured by the mass flow controller of the gaseous sample.

If additional gas flow is needed to increase the flowrate of the gas flow to the analytical device, makeup gas may be introduced into gas exchange device 130 at makeup port 148. A mass flow controller 164 may be positioned near the makeup port 148. For example, makeup gas may be nitrogen. Makeup gas also may be introduced at other positions to achieve the desired control of sample gas flow and system pressure

The mass flow controller 116, mass flow meter 160, pressure gauge 144, mass flow controller 164, and the like may be connected to a microprocessor-controlled device (“computer”), for example, to measure, monitor, and control the various inputs and flow rates. The computer may also be used to measure, monitor, and control all conditions including temperature and pressure. The computer may make adjustments based on the measured values, such as, e.g., changing flow rates, etc. In some embodiments, the computer may adjust the flow rate of the exchange gas, maintain the desired flow rate of the makeup gas, and/or control the pressure gauge and/or temperature to ensure desired conditions for maximum gas exchange are achieved.

In other aspects, with reference now to FIG. 7, system 300 may include gas chamber 302 dedicated for use with gaseous samples and includes a gas channel 322. Gas chamber 302 is connected to gaseous sample source 104, similar to the connection as described above for system 200, and is inserted into the system 300 and coupled with gas exchange device 130.

As described above in regards to system 200, mass flow controller 116 is used to control the flow rate of the sample gas from the gaseous sample source 104 via a gas flow conduit 112 that is coupled to chamber 302 by connector 114. A selector valve 118 at the gaseous sample source 104 is utilized to switch between different gaseous samples, such that a variety of gaseous samples each may be introduced to an analytical device 150 with system 300.

In gas chamber 302, gas channel 322 extends the length of the interior chamber 320 from the inlet wall 506 to the outlet wall 510 and discharges to the inlet 132 of the gas exchange device 130. Flow of gaseous sample through chamber 302 is directed through gas channel 322. Gas channel 322 may be positioned along the axis of the chamber or may be offset toward the chamber wall. Generally, gas channel 322 will be positioned so that it extends directly from a gas inlet port to an outlet port for an unobstructed flow path. Thus, the length of the gas channel typically corresponds to the length of the chamber 302 between the inlet end 500 and the outlet end 520.

Gas channel 322 may be flexible or rigid. It may be constructed of the same material that is used to line the interior wall 324 of the interior chamber 320 (or interior chamber 120) or a different material. In one aspect, the material is selected to be inert to the gaseous samples being processed. In certain examples, the gas channel 322 may comprise PFA or PTFE tubing. The diameter and thickness of the gas channel 322 also will depend at least in part on the location and size of a gas inlet port and gas outlet port. In one aspect, gas channel comprises 0.25 inch diameter PTFE tubing. Gas channel 322 is connected to gas inlet and outlet ports using any suitable connector to provide a secure and sealed connection.

If additional support is required for the gas channel 322 during operation, other features known to one of skill in the art, such as baffles, may be included to support or secure the gas channel. Chamber 302 is connected to gas exchange device 130, the features and operation of which are described above in regards to system 200.

When a gaseous sample is processed in system 300, the gaseous sample flow rate from the sample source 104 through the gas channel 322 and into gas exchange device 130 is measured and controlled using known techniques to limit pressure changes and facilitate proper gas exchange at the enclosed membrane 138. In certain aspects, a positive pressure is maintained to move the gaseous sample through the system 300 toward and into the gas exchange device 130. The flow rate of exchange gas from the enclosed membrane 138 also may be controlled to be consistent with the flow rate of process gas. In certain aspects, a mass flow meter 160 may be interfaced between the gas exchange device and the analytical device and tied to the mass flow controller 116. In embodiments, the mass flow meter 160 is in communication with the computer.

As discussed above for system 200, if additional gas flow is needed to maintain or adjust the pressure across the membrane 138 to obtain a desired gas exchange rate, makeup gas may be introduced into gas exchange device 130 at makeup port 148. Makeup gas may be the same gas as exchange gas or may be a different gas. The makeup gas may flow through and exit gas exchange device 130 with exchange gas. The makeup gas may also be used to increase the flowrate of the sample gas flow. Makeup gas also may be introduced at other positions to achieve the desired control of sample gas flow and system pressure. In one example embodiment where the exchange gas is argon, the makeup gas may be nitrogen, and the amount of makeup gas is determined while calibrating the disclosed methods and systems with a liquid standard.

FIG. 8 depicts an illustrative arrangement of equipment in a system 700 for preparing a liquid sample or a gaseous sample for introduction to an analytical device. In system 700, gaseous sample is conveyed from gaseous sample source 104 via gas flow conduit 112 to the inlet 132 of gas exchange device 130 where it is coupled by connector 714. A mass flow controller 116 is used to control the flow rate of the sample gas from the gaseous sample source 104. A selector valve 118 at the gaseous sample source 104 is utilized to switch between different gaseous samples, such that a variety of gaseous samples each may be introduced to an analytical device 150 with system 300. Liquid sample is conveyed from liquid sample source 102 via liquid flow conduit 108 to nebulizer 110 and chamber 106. In this arrangement, the gaseous sample bypasses the chamber 106. Liquid sample may be processed in chamber 106, as described above, before passing to inlet 132.

Gas flow conduit 112 is connected to gas exchange device 130 using any suitable connector 714, such as a swage type. In one aspect, a “T” connection between chamber 106 and gas exchange device 130 may be used to couple gas flow conduit 112 to chamber 106 and inlet 132 of gas exchange device 130.

With system 700, gaseous sample from gaseous sample source 104 is independently introduced to analytical device 150. Liquid sample is conveyed through chamber 106, as described above in regards to system 200.

As with other systems described herein, the gaseous sample flow rate from the sample source 104 into gas exchange device 130 is measured and controlled using known devices (e.g., mass flow meters, pressure gauges, etc.) to limit pressure changes and facilitate proper gas exchange at the enclosed membrane 138. In certain aspects, a positive pressure is maintained to move the gaseous sample through the system 700 toward and into the gas exchange device 130. The flow rate of exchange gas from the enclosed membrane 138 also may be controlled to be consistent with the flow rate of process gas during calibration. In certain aspects, a mass flow meter 160 may be interfaced between the gas exchange device and the analytical device and tied to the mass flow controller 116.

As discussed above for system 200, if additional gas flow is needed to maintain or adjust the pressure across the membrane 138 to obtain a desired gas exchange rate, makeup gas may be introduced into gas exchange device 130 at makeup port 148. Makeup gas may be the same gas as exchange gas or may be a different gas. The makeup gas may flow through and exit gas exchange device 130 with exchange gas. The makeup gas may also be used to increase the flowrate of the sample gas flow. Makeup gas also may be introduced at other positions to achieve the desired control of sample gas flow and system pressure.

A mass flow meter 160 may be interfaced between the gas exchange device and the analytical device. As previously discussed for system 200, in regard to gaseous samples, the flow rate or pressure at the outlet 134 of the gas exchange device 130 must be close to or the same as the flow rate or pressure of the sample gas measured at the mass flow controller 116 in order to maintain a linear response of contaminants to concentration. The mass flow meter 160 may be used to measure a flow of gas to the analytical device and the ratio of this value to that set by mass flow controller 116 may be monitored e.g., by the computer. Ideally the flow of gas is at least 98%, or at least 99%, of the flow of the gaseous sample as measured by the mass flow controller of the gaseous sample.

As discussed above and applied hereto as well, the membrane may be enclosed in a heater, and temperature is controlled between 80 and 180 C. Control of temperature and exchange gas flow/pressure ensure proper/efficient exchange as discussed fully above.

As discussed above and applied hereto as well, the mass flow controllers, 116, 162, and 164, mass flow meter 160, pressure gauge 144, and the like may be connected to a computer, for example, to measure, monitor, and control the various inputs and flow rates. The computer may also be used to measure, monitor, and control all conditions including temperature and pressure, make adjustments based on the measured values, such as, e.g., changing flow rates, etc., and/adjust the flow rate of the exchange gas, maintain the desired flow rate of the makeup gas, and/or control the pressure gauge and/or temperature to ensure desired conditions for maximum gas exchange are achieved.

It is to be understood that in each of the systems described herein, like features are indicated by like reference numbers and operate in a like manner in each system.

In any of the systems described herein, in operation, the gas exchange device may be initially calibrated using liquid standards according to calibration techniques known to those of skill in the art. Based on the calibration, the desired flow rates of the gaseous sample mass flow controller 116, exchange gas mass flow controller 162, and/or makeup gas (e.g., nitrogen) mass flow controller 164 may be determined. These values are generally set at the beginning of the process and then monitored. Liquid standard 102 is aspirated through the sample line 108 to the nebulizer 110, the liquid is nebulized into a linear path heated spray chamber 124 (temperature between 120 and 130° C.). Heating the spray chamber evaporates the liquid part of the aerosol facilitating its exchange in the GED 130. The dry aerosol is then carried to the ICP-MS 150. Nitrogen may be added at inlet port 148 to improve ionization in the plasma.

In addition to the aspects discussed above, a gas exchange device may comprise two interchangeable chambers 106, one for introduction of gaseous samples to the gas exchange device and one for the introduction of liquid samples to the gas exchange device. Such device is described in US20200035475A1.

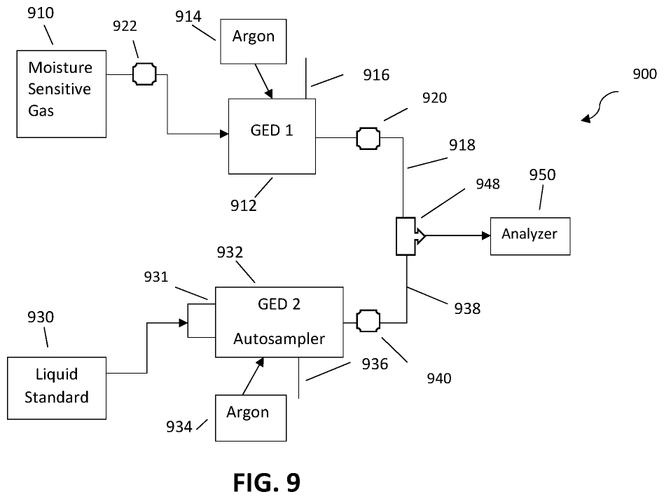

If there is concern of moisture in the gas, then a two GED system may be used as identified in co-pending application (Attorney Docket008916.00365), where separate gas exchange devices are used for the gaseous stream and the liquid calibrant stream prior to delivery of the gaseous sample and the calibrant sample to the analytical device. For example, FIG. 9 depicts an example system 900. A gas exchange device and an analytical device are used to detect contaminants (particles) in a moisture sensitive gas stream. A gas exchange device is also used to process a liquid calibrant stream to calibrate the analytical device via a method of standard addition using liquid standards.

Moisture sensitive gas 910 is introduced into a gas exchange device 912 (GED 1). An exchange gas 914, e.g. Argon, is introduced into the gas exchange device. Contaminants (particles) present in the moisture sensitive gas are transferred to the exchange gas in the gas exchange device 912. The moisture sensitive gas is removed from the gas exchange device via conduit 916. The exchange gas containing contaminants 918 exits from the gas exchange device 912 and is transported to analytical device 950. A mass flow meter 920 may be interfaced between the gas exchange device 912 and the analytical device 950 to control flow rate of the gaseous sample stream. A mass flow meter 922 may also be placed between the moisture sensitive gas source and the gas exchange device 912.

Liquid standard 930 containing a calibrant is introduced into a gas exchange device 932 (GED 2) through an inlet aperture and typically via a nebulizer 931 which aerosolizes the liquid, creating a mist. An exchange gas 934, e.g. Argon, is introduced into the gas exchange. Calibrant present in the aerosolized liquid is transferred to the exchange gas. The aerosolized liquid is removed from the gas exchange device via conduit 936. The exchange gas containing calibrant 38 exits gas exchange device 912 and is transported to analytical device 950. A mass flow meter 40 may be interfaced between the gas exchange device 932 and the analytical device 950. A mass flow meter may also be placed between the liquid calibrant source and the gas exchange device 932.

Conduit 918 and conduit 938 may be connected via a T-connection 948 prior to entering the analytical device 950. For example, the T-connection may be made with any suitable polymer such as, but not limited to, perfluoroalkoxy alkanes (PFA.)

Although the elements of FIG. 9 are shown as block diagrams, the disclosure is not so limited. In particular, one or more of the boxes in FIG. 9 may be combined into a single box or the functionality performed by a single box may be divided across multiple existing or new boxes.

Introduction into the Analytical Device

As seen in FIG. 5, exchange gas containing the plurality of particles is introduced into the analytical device 18. A sample introduction device 20 is configured to accept the exchange gas stream containing a plurality of particles and provide an individual particle from the plurality of particles. The sample introduction device 20 is configured to directly inject the individual particle into the ionization device 22.

An ionization device 22 fluidically coupled to the sample introduction device 20 and configured to ionize elemental species present in the provided individual particle. The ionization device 22 may contain a torch and an induction device configured to sustain an inductively coupled plasma within the torch. The induction device may be configured as an induction coil, a plate electrode, or a radially finned induction device.

An optical detector 24 is configured to simultaneously detect an optical response from each of the ionized elemental species from the provided individual particle. The optical detector may be an optical spectrometer. The optical detector may contain at least one grating to spatially separate each optical emission wavelength from other optical emission wavelengths to permit simultaneous detection of each of the ionized elemental species.

A second ionization device may be fluidically coupled to the sample introduction device, the second ionization device and the ionization device configured to operate in parallel. A second detector may be fluidically coupled to the second ionization device, the second detector configured to simultaneously detect optical emissions from each of the ionized elemental species present in the second ionization device.

A processor may be electrically coupled to the optical detector and configured to execute instructions for quantifying an amount of each element from a detected optical emission from each of the ionized elemental species, wherein the processor is further configured to determine a source of the particle using the quantified amount of each element. A sampling device may be fluidically coupled to the ionization device in a first state and fluidically coupled to the second ionization device in a second state.

The analytical device may include an inductively coupled plasma-optical emission spectrometry (ICP-OES) other analytical device with an effective ionization source for elemental species. In some examples, the ionization source may be a high temperature ionization source, e.g., one with an average temperature of about 4000 Kelvin or more, such as, for example, a direct current plasma, an inductively coupled plasma, an arc, a spark or other high temperature ionization sources. The ionization source should be coupled to a simultaneous multielement detection spectrometer with microsecond data acquisition speed. and a single particle ICP-OES. See, for example, Canadian patent 2938674C.

A sample of the exchange gas containing the plurality of particles is analyzed. The plurality of particles contains at least a single particle containing at least a first element and a second element. Each of the first element and the second element may be inorganic elements.

The sample is ionized to provide an excited, ionized first element and an excited, ionized second element. Simultaneously, a wavelength of an optical emission from each of the excited, ionized first element and a wavelength of the excited, ionized second element are detected. These are detected to 1) identify at least the first element in the particle from the plurality of particles using the optical emission from the excited, ionized first element, and 2) identify at least the second element in the particle from the plurality of particles using the optical emission from the excited, ionized second element. The identified first element and the identified second element are used to identify a source of the particle.

The process may also simultaneously detect an optical emission from an ionized third element to identify a third element in the particle using the optical emission from the ionized third element and identifying the source of the particle using the identified first, second and third elements. The process may also simultaneously detect an optical emission from each ionized element from up to all elements in the particle to identify up to all elements in the particle.

The process may further be used to quantify an amount of each of the first element and the second element in the particle, or each of the first element, the second element and the third element in the particle, up to all elements in a particle.

The process may be used for identifying elements in a nanoparticle or a microparticle, for example having an average diameter of about 100 nm to about 100 microns

It is to be understood that in each of the systems described herein, like features are indicated by like reference numbers and operate in a like manner in each system.

The analytical device should be properly calibrated, typically via incremental calibrant concentrations from liquid standards as discussed above. A liquid calibrant stream contains at least one calibrant.

The gaseous stream may contain at least one particle selected from the group consisting of transition metals and heavy metals such as, but not limited to, Na, Mg, Al, Mo, W, Pb, Ti, Cr, Fe, Ni, Co, Cu, Zn, K, Ca, and Mn. The gaseous stream containing the at least one particle may be a stream containing air, He, LAr, LN₂, N₂O, NF₃, and/or NH₃. For example, gaseous samples that may be prepared using the systems described herein include, but are not limited to those gases listed in Table 1 and air (ambient/lab).

TABLE 1

| Tested | Possible Gases | Others* |
|---|---|---|
| He | CHF₃ | C₂HF₅ |
| LAr | CF₄ | 100% C₄F₈ |
| LN₂ | C₃H₆ | 100% CH₂F₂ |
| N₂O | C₂H₄/He | 100% C₂HF₅ |
| NF₃ | CH₄/Ar | 100% Si₂H₆ |
| 100% NH₃ | 5% H₂/4% N₂ | 20% PH₃/H₂ |
| CO₂ | 4% H₂/N₂ | 10% GeH₄/He |
| C₄H₂F6 | 100% C₂H₄ | 10% Ge₂H₆/H₂ |
| CO | 100% CH₄ | |
| SF₆ | BF₃ | |
| | 1% BCl₃/N₂ | |
| | 20% F₂/N₂ | |
| | O₂/He | |
| | 1.2% He/N₂ | |
| | 100CH₂F₂ | |
| | 5% PH₃/N₂ | |
| | 0.1% B₂H₆/H₂ | |
| | 4% PH₃/He | |

*Need to modify GED (safety and temperature control)

In certain aspects, the efficiency of the gas exchange device 130 is about 97% or greater, about 97.98% or greater, about 98% or greater, or about 99% or greater.

Flow rates for the gaseous samples may be 0 to 2 L/min, for example 0.2 to 1.8 L/min, or 0.4 to 1.5 L/min. Exchange gas flow rate between 0 and 12 L/min. Makeup gas may be between 0 and 50 mL/min, for example, about 1 to 45 mL/min.

Once the particle-containing liquid samples and/or gaseous samples are processed in any of the systems described herein, data generated by the analytical device can be analyzed by techniques known to those of skill in the art, including techniques described in U.S. Patent Application Publication No. 2015/0235833, the disclosure of which is incorporated herein in its entirety.

It is to be understood that any gas phase or particle sample analysis system is to be considered equivalent and may be used instead.

### Example

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method for single particle compositional analysis, the method comprising:
a) transferring a gaseous stream containing a plurality of particles from a gaseous source to a gas exchange device;
b) passing the gaseous stream through the gas exchange device;
c) injecting exchange gas through the gas exchange device countercurrent to the gaseous stream, wherein the plurality of particles is transferred to the exchange gas;
d) outputting the exchange gas to an analytical device; and
e) analyzing the exchange gas in the analytical device comprising:
ionizing a sample of the exchange gas containing the plurality of particles, wherein the plurality of particles comprises a particle comprising at least a first element and a second element, and wherein ionization of the sample provides excited, ionized first element and excited, ionized second element;
simultaneously detecting a wavelength of an optical emission from each of the excited, ionized first element and the excited, ionized second element to identify at least the first element in the particle from the plurality of particles using the optical emission from the excited, ionized first element, and to identify at least the second element in the particle from the plurality of particles using the optical emission from the excited, ionized second element; and
using the identified first element and the identified second element to identify a source of the particle.

2. The method of claim 1 further comprising injecting makeup gas to the gas exchange output to provide an output flow rate that is at least 98% of the flow rate of the gaseous stream from the gaseous source.

3. The method of claim 1 wherein at least 99.8% of gas of the gaseous stream is exchanged with the exchange gas in the gas exchange device.

4. The method of claim 1 wherein the exchange gas is Argon.

5. The method of claim 1, wherein each of the first element and the second element are inorganic elements.

6. The method of claim 1, further comprising quantifying an amount of each of the first element and the second element in the particle.

7. The method of claim 1, further comprising simultaneously detecting an optical emission from an ionized third element to identify a third element in the particle using the optical emission from the ionized third element and identifying the source of the particle using the identified first, second and third elements.

8. The method of claim 7, further comprising quantifying an amount of each of the first element, the second element and the third element in the particle.

9. The method of claim 1, wherein the gaseous stream comprising the particle is selected from a stream containing air, helium (He), liquid argon (Lar), liquid nitrogen (LN₂), nitrous oxide (N₂O), nitrogen trifluoride (NF₃), and ammonia (NH₃).

10. The method of claim 1, further comprising simultaneously detecting an optical emission from each ionized element from all elements in the particle to identify all elements in the particle.

11. The method of claim 10, further comprising quantifying each of the identified elements in the particle and determining a source of the particle using the quantified elements.

12. The method of claim 1, further comprising identifying the particle as a nanoparticle or a microparticle.

13. The method of claim 12, further comprising identifying the source of the nanoparticle or microparticle using the identified first element and the identified second element.

14. The method of claim 1, further comprising ionizing the particle to provide the ionized first element and the ionized second element.

15. The method of claim 14, wherein the ionizing comprises introducing the particle into an ionization source.

16. The method of claim 15, further comprising configuring the ionization source as one of an inductively coupled plasma, a capacitively coupled plasma, a glow discharge, an arc, or a spark.

17. The method of claim 1 further comprising
a1) selectively alternately transferring a liquid stream containing calibrant particles from a liquid source to the gas exchange device, wherein the liquid stream is aerosolized prior to the gas exchange device;
b1) passing the aerosolized liquid stream through the gas exchange device;
c1) injecting exchange gas through the gas exchange device countercurrent to the aerosolized liquid stream, wherein calibrant particles are transferred to the exchange gas; and
d1) outputting the exchange gas to an analytical device.

18. A system for single particle compositional analysis, the system comprising at least a gas exchange apparatus, a sample introduction device, an ionization device, and an optical detector;
the gas exchange apparatus comprising:
a gas exchange device having an inlet aperture and an outlet aperture; and
a conduit coupled to the outlet aperture and configured to transfer output of the gas exchange device to the sample introduction device, the output comprising exchange gas comprising a plurality of particles;
the sample introduction device configured to provide an individual particle from the plurality of particles, wherein the provided individual particle comprises an average diameter of about 100 nm to about 100 microns;
an ionization device fluidically coupled to the sample introduction device and configured to ionize elemental species present in the provided individual particle; and
an optical detector configured to simultaneously detect an optical response from each of the ionized elemental species from the provided individual particle.

19. The system of claim 18 wherein the sample introduction device is configured to directly inject the individual particle into the ionization device.

20. The system of claim 18, wherein the optical detector comprises an optical spectrometer.

21. The system of claim 20, further comprising a processor electrically coupled to the optical detector and configured to execute instructions for quantifying an amount of each element from a detected optical emission from each of the ionized elemental species, wherein the processor is further configured to determine a source of the particle using the quantified amount of each element.

22. The system of claim 18, wherein the optical detector comprises at least one grating to spatially separate each optical emission wavelength from other optical emission wavelengths to permit simultaneous detection of each of the ionized elemental species.

23. The system of claim 18, wherein the ionization device comprises a torch and an induction device configured to sustain an inductively coupled plasma within the torch.

24. The system of claim 23, wherein the induction device is configured as an induction coil, a plate electrode or a radially finned induction device.

25. The system of claim 18, further comprising a second ionization device fluidically coupled to the sample introduction device, the second ionization device and the ionization device configured to operate in parallel.

26. The system of claim 25, further comprising a second detector fluidically coupled to the second ionization device, the second detector configured to simultaneously detect optical emissions from each of the ionized elemental species present in the second ionization device.

27. The system of claim 26, further comprising a sampling device fluidically coupled to the ionization device in a first state and fluidically coupled to the second ionization device in a second state.

28. The system of claim 18 further comprising a gas flow conduit to convey a gaseous sample stream from a gaseous sample source to the inlet aperture of the gas exchange device.

29. The system of claim 28 further comprising a mass flow controller connected to the gas flow conduit to control flow rate of the gaseous stream.

30. The system of claim 18 further comprising a mass flow meter interfaced between the gas exchange device and the sample introduction device.

31. The system of claim 18 wherein the gas exchange device comprises a cylindrical housing, extending along an axis, and enclosing a membrane for removal and transfer of particles from a gaseous stream to an exchange gas stream.

32. The system of claim 31, wherein the gas exchange device is configured to accept the gaseous stream and an aerosolized liquid stream.
